(19) United States
(12) Patent Application Publication
(10) Pub. No.: US 2001/0000970 A1
(43) Pub. Date: May 10, 2001

(54) Information processing method and apparatus

(75) Inventor: Satoshi Ejima, Tokyo (JP)

Correspondence Address: OLIFF & BERRIDGE, PLC, P.O. Box 19928, Alexandria, VA, 22320, US

(73) Assignee: NIKON CORPORATION

(21) Appl. No.: 09/752,772

(22) Filed: Jan. 3, 2001

Related U.S. Application Data
(63) Continuation of application No. 08/874,247, filed on Jun. 13, 1997, now abandoned.

(30) Foreign Application Priority Data
Jun. 14, 1996 (JP) 08-153820

(51) Int. Cl. H04N 5/222

(52) U.S. Cl. 348/232; 348/333.02; 348/333.05

(57) ABSTRACT

In electronic camera and other applications, the reproduction of image or other data is controlled according to day and time information related to the time of taking a picture, or otherwise recording data. In reproduction, the reproduction images are reproduced in the order determined by the date of the recording data being contained in the reproduction object, for instance, with the latest date being reproduced first.

### INCORPORATION BY REFERENCE

1. The disclosures of the following priority application(s) are herein incorporated by reference: Japanese Patent Application No. 08-153820, filed Jun. 14, 1996.

### BACKGROUND OF THE INVENTION

2. 1. Field of Invention

3. The present invention relates to an information processing apparatus, and in particular, an information processing apparatus to which information such as sound, image or line drawing is input, and which records these pieces of information with an input day and time.

4. 2. Description of Related Art

5. In electronic camera and other products known in the prior art, photographed images are recorded chronologically in a memory apparatus, such as electronic memory, and are reproduced in the order in which they were stored in the memory (chronologically).

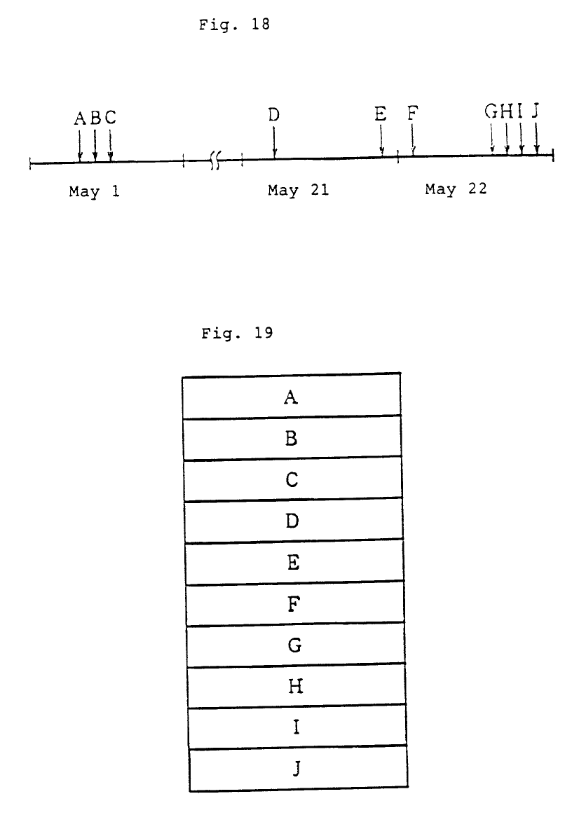

6. For example, if three images, A through C, are recorded in an electronic camera on May 1, two images, D through E, are recorded on May 21, and five images, F through J are recorded on May 22, as described in FIG. 18, these images are stored sequentially in a memory in the order shown in FIG. 19.

7. In such an electronic camera, if a plurality of images are stored in memory and these images are later reproduced, the images are reproduced chronologically according to the day and time of shooting. In other words, during playback in the example of FIG. 19, image A is reproduced first, followed by image B through image J in that order.

8. In such case, for example, suppose images G through image J are photographed and suppose these images are to be reproduced for verification, then all the images previously shot (image A through image F) are reproduced before display or reproduction of the desired images, G through J. Hence, substantial time is wasted before the reproduction of desired images is achieved.

### SUMMARY OF THE INVENTION

9. Considering the problems described above, the invention aims among other things to reduce the time needed for reproduction of desired information recorded in an electronic camera or other data recording device.

10. An information processing apparatus according to the invention in one aspect relates to an input part for inputting information, a clock for clocking day and time, a recording part for recording the information which is input from the input part and for recording input day and time at the time of inputting that information, a composition part for composing that information according to the input day and time recorded by the recording part, a selection part for selecting, in predetermined order, at least one reproduction object composed in the composition part, and a reproduction part for reproducing the information contained in the reproduction part being selected by the selection part, according to the input day and time recorded in the recording part.

11. In an information processing embodiment so described, the clock clocks the day and time, the recording part records the information from the input part and records the day and time at the time the information (such as an image) is input, the composition part composes a reproduction object according to the input day and time recorded by the recording part, the selection part selects, in predetermined order, at least one reproduction object composed by the composition part, and the reproduction part reproduces the information contained in the reproduction object selected by the selection part, according to the input day and time recorded in the recording means. Hence, the information being recorded may be conveniently reproduced in any desired order.

12. An information processing apparatus according to the invention in another aspect relates to an input part for inputting the information, a clock for clocking day and time, a recording part for recording the information input from the input part, and for recording the day and time at the time of inputting that information, a calendar display, a designation part for designating a predetermined day and time in the calendar displayed by the calendar display, a retrieval part for retrieving information having the day and time designated by the designation part as an input day and time from the recording part, and a reproduction part for reproducing information retrieved by the retrieval part.

13. In an information processing embodiment so described, the input part inputs the information, the clock clocks the day and time, the recording part records the information input from the input part and the date and time of inputting the information, the designation part designates a day and time in the calendar displayed by the calendar display means, the retrieval part retrieves information having the day and time designated by the designation part as an input day and time from the recording part, and the reproduction part reproduces information retrieved by the retrieval part. Hence, the information being recorded may be reproduced by designating day and time information in the calendar. In this manner, desired information may be reproduced quickly.

### BRIEF DESCRIPTION OF THE DRAWINGS

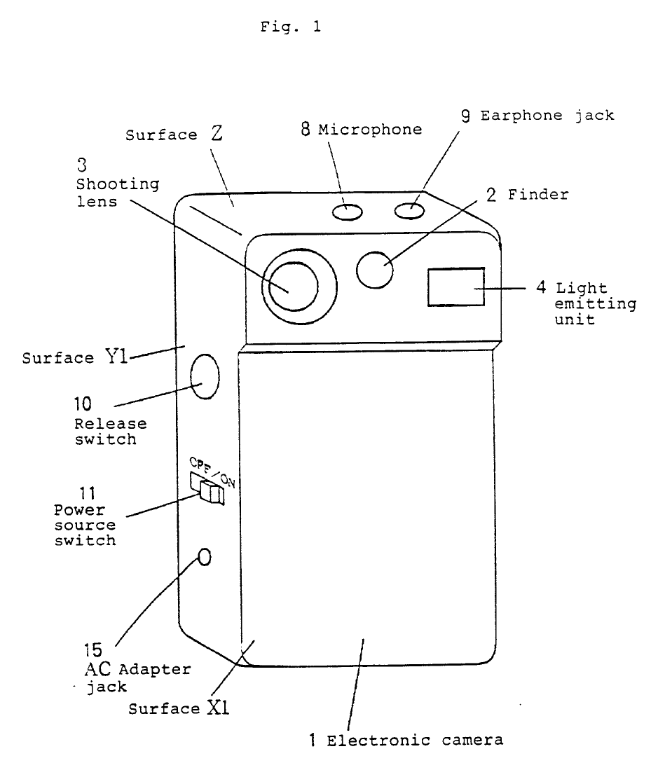

14. FIG. 1 is an oblique view of an electronic camera in which the information processing apparatus of the present invention is illustratively used;

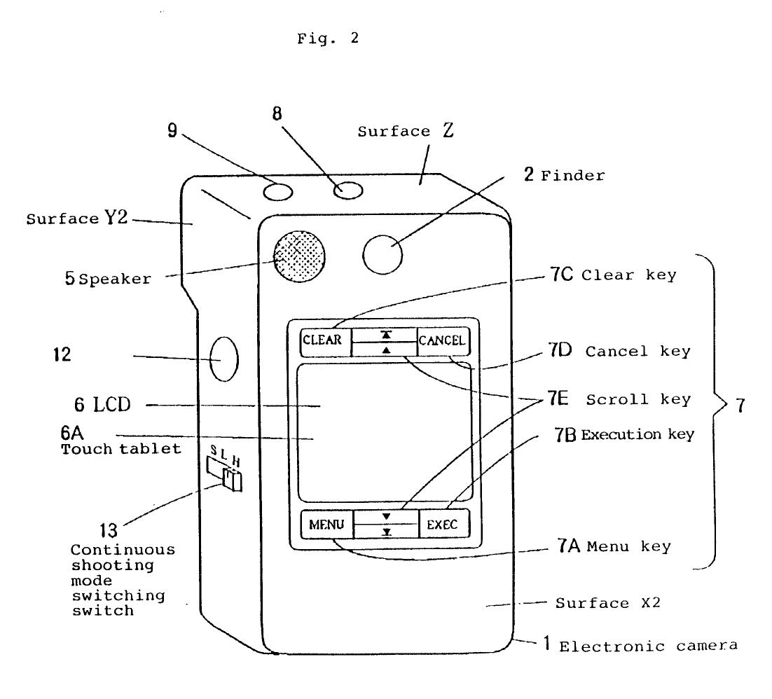

15. FIG. 2 is an oblique view of the electronic camera of FIG. 1 from a surface X1;

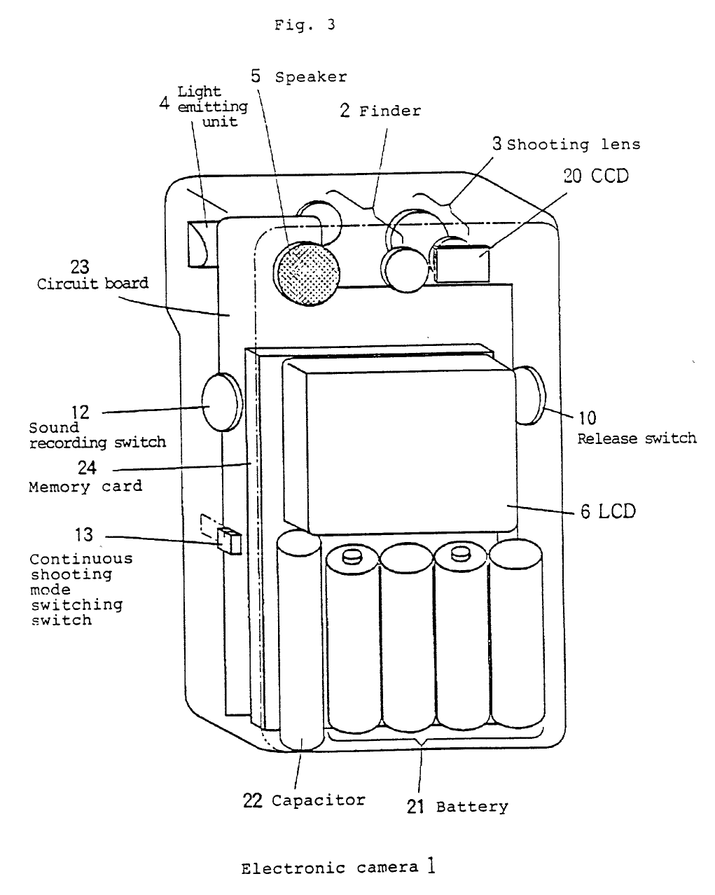

16. FIG. 3 is an oblique view of an internal structure of the electronic camera described in FIG. 1;

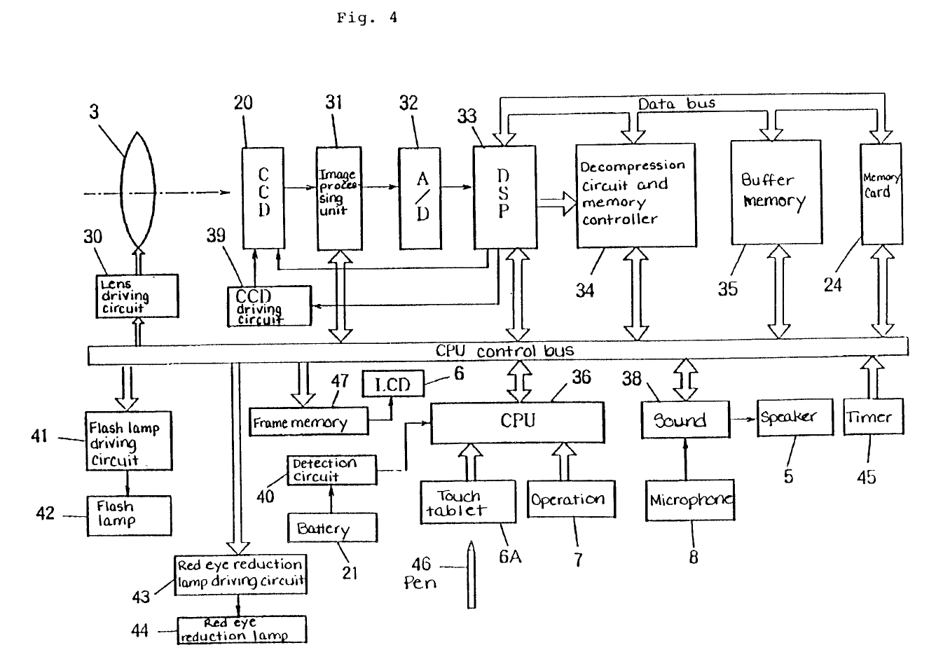

17. FIG. 4 is a block illustrating an electrical structure of the electronic camera described in FIG. 1;

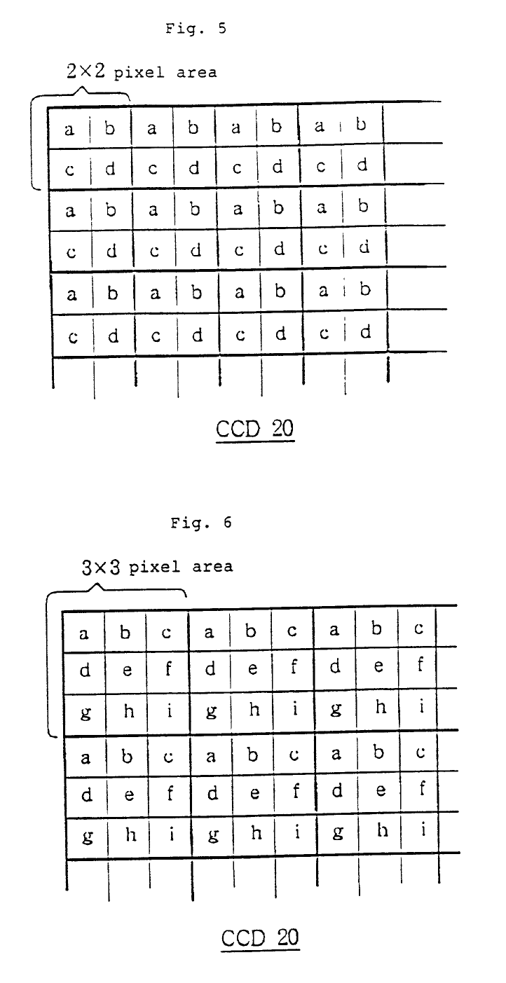

18. FIG. 5 is a diagram illustrating a pixel skipping process in L-mode;

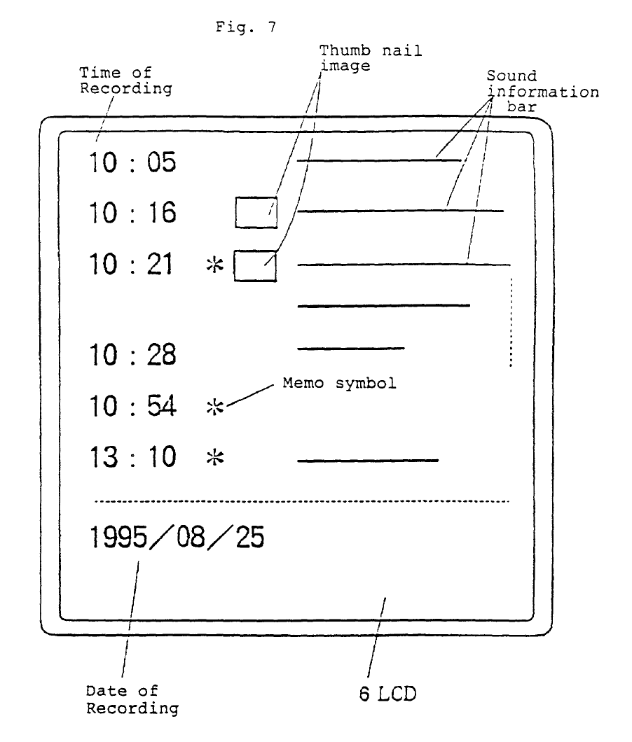

19. FIG. 6 is a diagram illustrating a pixel skipping process in S-mode;

20. FIG. 7 is a diagram illustrating a display example of a display screen when the recorded information is reproduced;

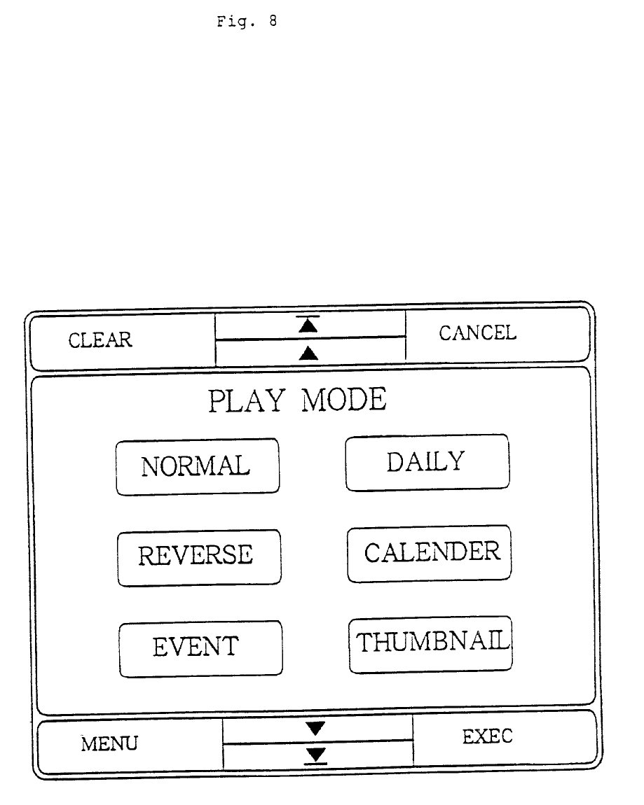

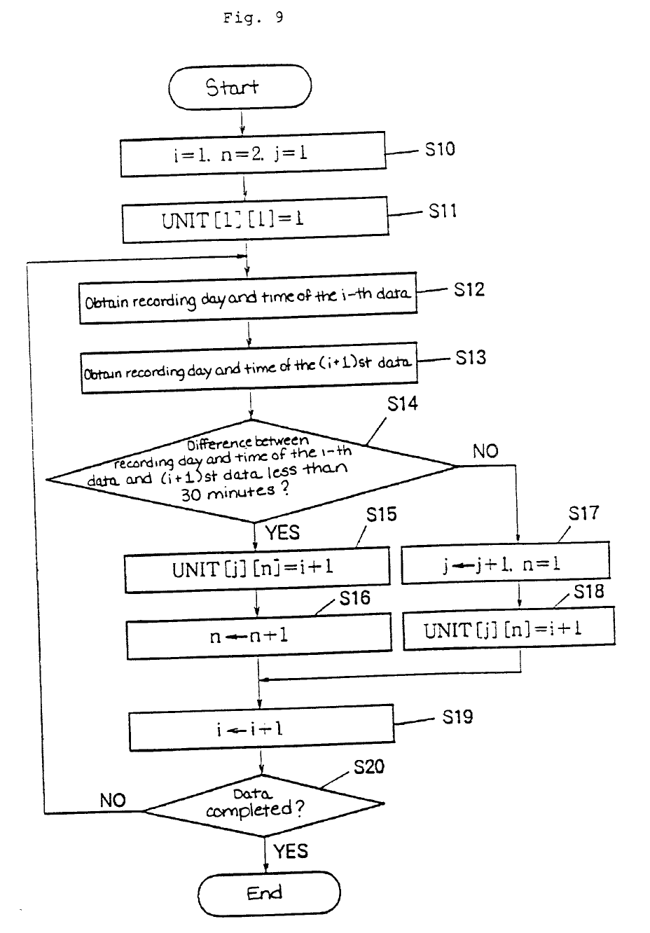

21. FIG. 8 is a diagram illustrating a display example of the selection screen in reproduction mode;

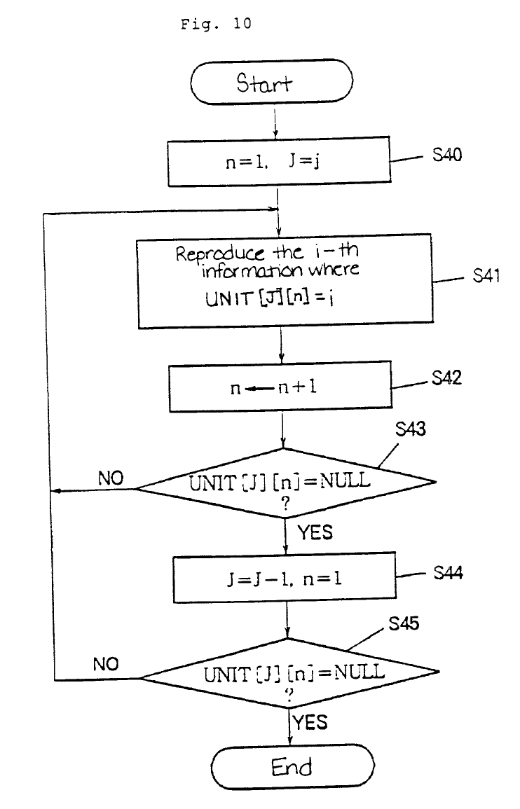

22. FIG. 9 is a flow chart illustrating a process for composing a reproduction object in event reproduction mode;

23. FIG. 10 is a flow chart illustrating a process for reproducing the reproduction object composed by the process of FIG. 9;

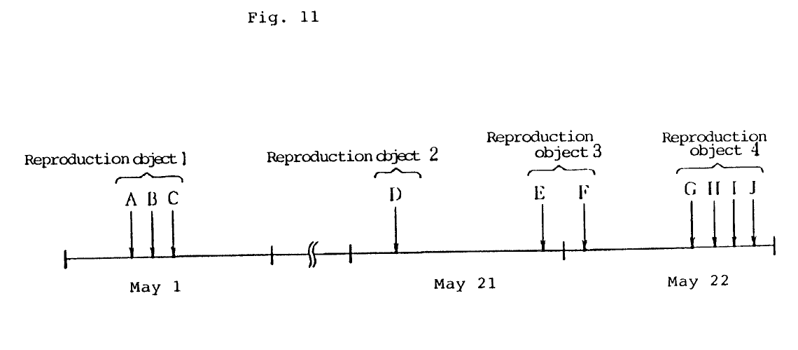

24. FIG. 11 is a diagram illustrating a reproduction object composed by the process of FIG. 9;

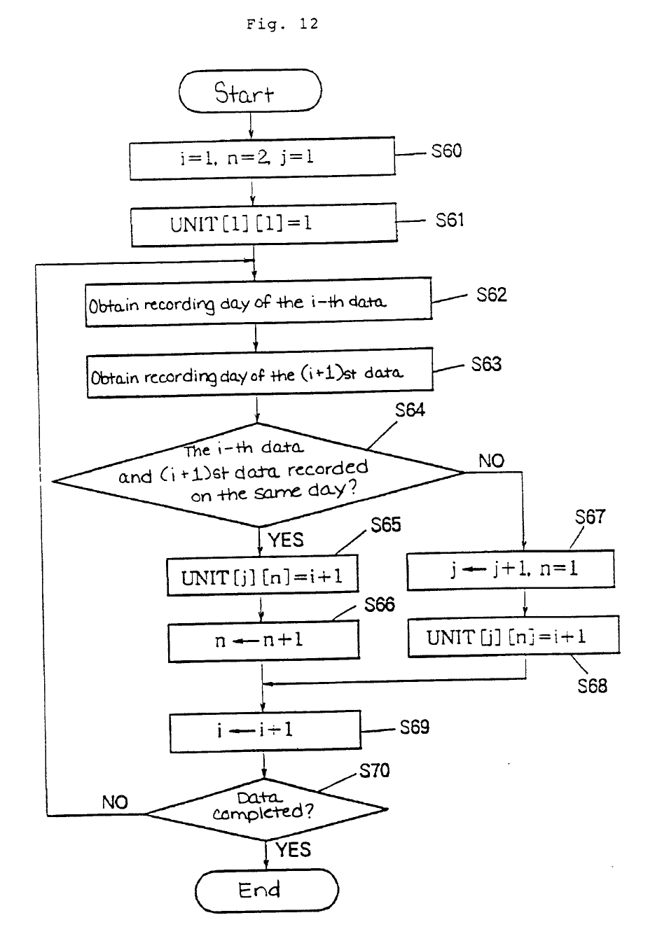

25. FIG. 12 is a flow chart illustrating a process for composing a reproduction object in a daily reproduction mode;

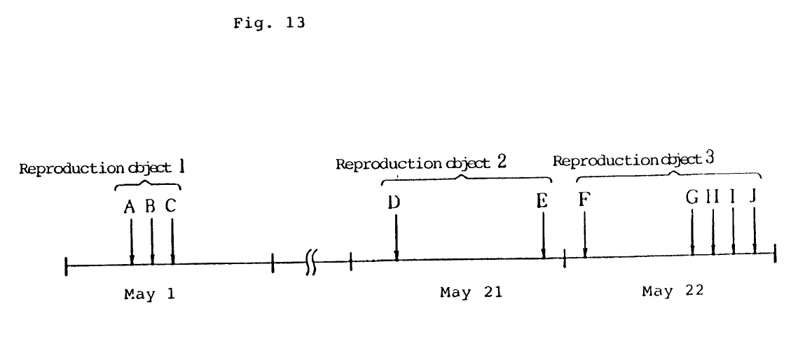

26. FIG. 13 is a flow chart illustrating a process for reproducing the reproduction unit composed by the process of FIG. 12;

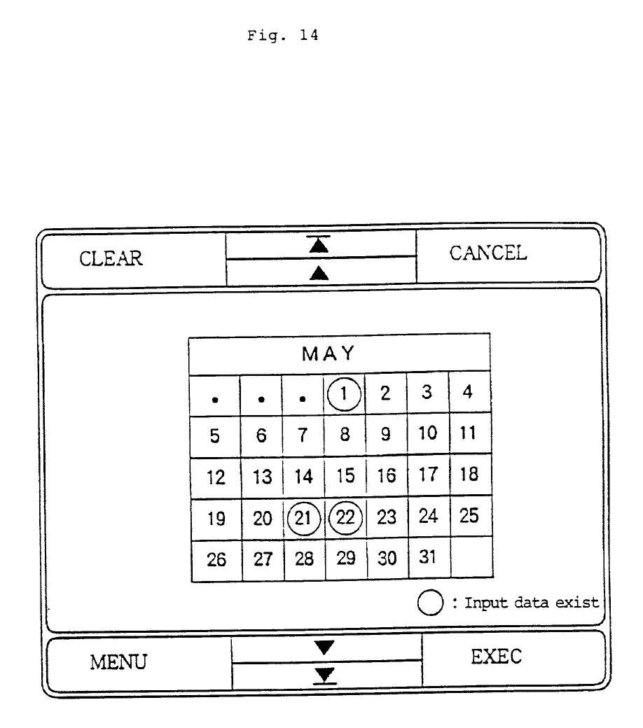

27. FIG. 14 is a diagram illustrating a display example of the calendar reproduction mode;

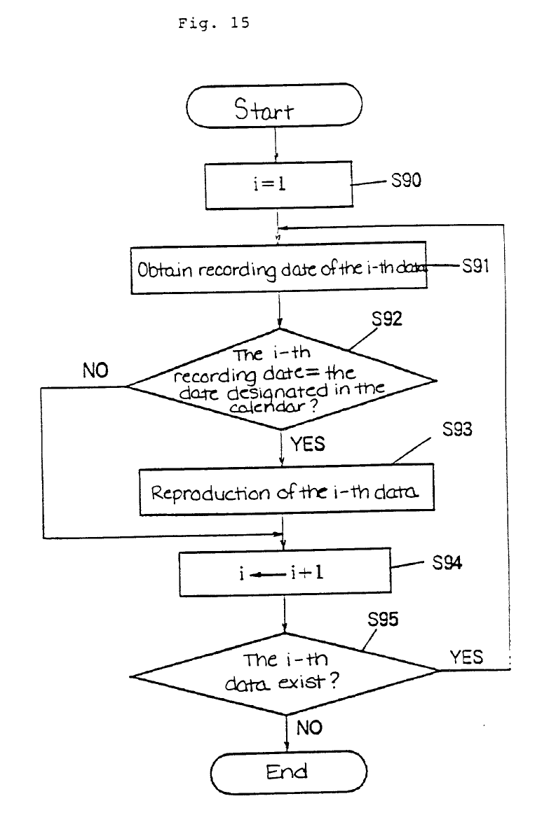

28. FIG. 15 is a flow chart illustrating a reproduction process in the calendar reproduction mode;

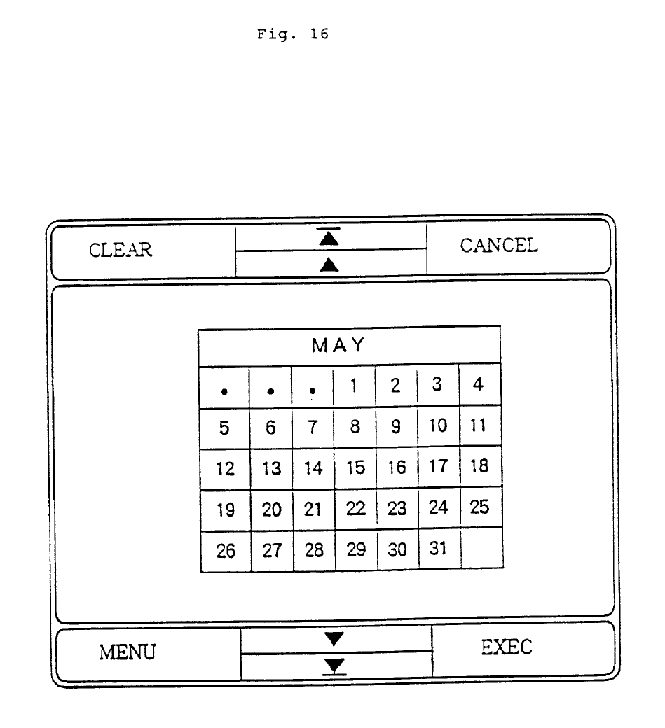

29. FIG. 16 is a diagram illustrating a display example of a calendar displayed in another mode than calendar reproduction mode;

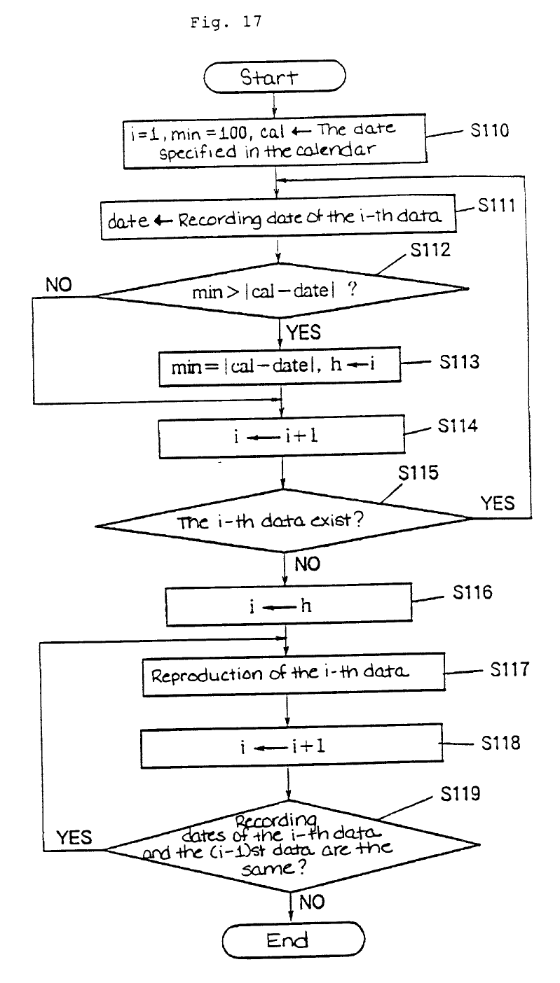

30. FIG. 17 is a flow chart illustrating a reproduction process for reproducing recording data from the calendar shown in FIG. 16;

31. FIG. 18 is a diagram illustrating a history of data recording in an electronic camera of the prior art; and

32. FIG. 19 is a diagram illustrating an order of recording data in memory when data are recorded in the order shown in FIG. 18, in an electronic camera of the prior art.

### DETAILED DESCRIPTION OF PREFERRED EMBODIMENTS

33. FIGS. 1 and 2 are oblique diagrams showing structural examples of an embodiment of an illustrative electronic camera, in which the present invention is advantageously used. In the electronic camera of the illustrative embodiment, the surface facing the object is defined as surface X1, and the surface facing the user is defined as surface X2 when the object is photographed. On the top edge section of the surface X1, there is provided a finder 2 to verify the shooting range of the object, a shooting lens 3 which takes in the optical image of the object, and a light emitting unit (flash lamp) 4 which emits light to illuminate the object being shot.

34. On the top edge section of the surface X2 (a section corresponding to the part of X1 where finder 2, shooting lens 3 and light emitting unit 4 are formed) which faces surface X1, the finder 2 and a speaker 5 which outputs sound recorded in the electronic camera 1 are provided. LCD 6 is provided to function as a reproduction part, including a calendar display and having operation key 7 (including menu key 7A, an execution key 7B, a clear key 7C, a cancel key 7D and a scroll key 7E) formed in the surface X2 vertically below finder 2, shooting lens 3, light emitting unit 4 and the speaker 5. On the surface of LCD 6, a so-called touch tablet 6A is arranged which outputs position data corresponding to the position designated by a touching operation of a pen or other pointing device. Touch tablet 6A is made of transparent material such as glass or resin, and the user may view an image being displayed on LCD 6 formed inside the touch tablet 6A through the touch tablet 6A.

35. Operation key 7 is a key operated in retrieving and displaying recording data on LCD 6, and is composed of the following keys. Menu key 7A is operated when a menu screen is displayed on LCD 6. The execution key 7B is operated when recording information selected by the user is carried out.

36. Clear key 7C is operated when recorded information is deleted. Cancel key 7D is operated when the process of recording information is interrupted. Scroll key 7E is operated in scrolling the screen vertically when the recording information is displayed on LCD 6, as a table.

37. A microphone 8 to gather sound and an earphone jack 9 to which an earphone (not shown) is connected are provided in the surface Z, which is the top surface of the electronic camera 1.

38. A release switch 10 which is operated in shooting an object and a power source switch 11 and an AC adapter jack 15 for connecting an AC adapter are provided on the left side surface (surface Y1).

39. Sound recording switch 12 to be operated when recording sound and a continuous shooting mode switching switch are provided in the surface Y2 (right surface) facing the surface Y1. Moreover, the sound recording switch 12 and the release switch 10 of the surface Y1 are formed virtually at the same height, so that the user does not feel a difference when the camera is held either in the right or left hand.

40. Here, the height of the sound recording switch 12 and the release switch 10 may be intentionally changed so that if the user accidentally presses the switch provided in the opposite side surface when the other switch is pressed, the user's fingers hold the other side surface to offset the moment created by the pressing of the switch.

41. The continuous shooting mode switching switch 13 is used when the user decides to shoot one or several frames of a desired object when pressing the release switch 10. For example, if the indicator of the continuous shooting mode switch 13 is pointed to the position printed “S” (in other words, when the switch is changed to S mode), and the release switch 10 is pressed, the camera is made to shoot only one frame.

42. If the indicator of the continuous shooting mode switch 13 is pointed to the position printed “L” (in other words, when the switch is changed to L mode), and the release switch 10 is pressed, the camera is made to shoot eight frames per second as long as the release switch 10 is pressed (namely, a low speed continuous shooting mode is enabled).

43. Furthermore, if the indicator of the continuous shooting mode switching switch 13 is pointed to the position printed “H” (in other words, when the switch is changed to H mode), and the release switch 10 is pressed, the camera is made to shoot 30 frames per second as long as the release switch 10 is pressed (namely, a high speed continuous shooting mode is enabled).

44. FIG. 3 is an oblique diagram illustrating an example of an internal structure of the electronic camera shown in FIGS. 1 and 2. CCD 20 (an input means) is provided in the rear step (surface X2 side) of the shooting lens 3, and the optical image of the object imaged through the shooting lens 3 is converted to electrical signals through this part.

45. Four cylindrical batteries (AAA dry cell batteries) 21 are placed side by side vertically below LCD 6 and the electric power stored in the batteries 21 is supplied to each part. A capacitor 22 accumulates electric charge for causing the light emitting unit 4 to emit light, arranged next to the batteries 21.

46. Various control circuits are formed on the circuit board 23 to control each part of the electronic camera 1. A removable memory card 24 (memory means) is provided between the circuit board 23, LCD 6 and the batteries 21 so that various pieces of information which are input in the electronic camera 1 are recorded or stored in a preassigned area of the memory card 24.

47. Moreover, in the configuration of the illustrated embodiment, the memory card 24 is removable, but a memory in which various pieces of information can be recorded may also be provided on the circuit board 23. Moreover, various pieces of information recorded in the memory (memory card 24) may be output to an external personal computer and the like, through a suitable interface (not shown).

48. In reference to the block diagram of FIG. 4, a lens driving path 30 is controlled by CPU 36 and executes an auto focus action by moving the shooting lens in the direction of the optical axis. CCD 20 which is equipped with a plurality of pixels converts the optical image imaged on each pixel into electrical image signals. The CCD driving circuit 39 is controlled by the digital signal processor (hereafter DSP) 33, and drives CCD 20.

49. The image processing unit 31 performs a double correlation sampling on image signals output by CCD 20 with a predetermined timing, and controls the signal values of the sampled image signals to become optimum, using an automatic gain control. An analog/digital conversion circuit (hereafter, A/D conversion circuit) digitizes the image signals sampled by the image process unit 31 and supplies them to a digital signal processor 33.

50. DSP 33 executes a predetermined process on the digitized image signals and supplies the results to the compression/decompression and memory controller (hereafter, the compression unit) 34. The decompression circuit 34 compresses the image signals being supplied from DSP 33 (hereafter, simply shooting image data) and stores the shooting image data in a predetermined area (shooting image recording area) of the memory card 24.

51. A timer (clocking circuit) records shooting date information (year, month, date, time) as header information of the image data in the shooting image recording of the memory card 24. In other words, the shooting image data to be recorded in the memory card 24 includes the recording date data.

52. A microphone 8 inputs sound, converts it to electric signals and supplies the results to a sound IC (integrated circuit) 38. The sound IC 38 A/D-converts the sound signals being input, executes a compression/decompression process using ADPCM (adaptive differential pulse code modulation) as understood by persons skilled in the art, and supplies the resulting audio data to CPU 36 through the CPU control bus (not shown).

53. CPU 36 records the sound data which is compressed after being digitized in the predetermined area (sound recording area) of the memory card 24 through the CPU control bus. Moreover, the recording date data is recorded at this time as header information of the sound data in the sound recording area of the memory card 24.

54. When the touch tablet 6A is pressed by the pen type pointing device (hereafter, a pen) 46 operated by the user, CPU 36 reads the X-Y coordinate of the pressed position in the touch tablet 6A and stores the coordinate data (line drawing information to be explained later) in the buffer memory 35. CPU 36 records the stored line drawing information with the header information of the line drawing information input date in the line drawing information recording area of memory card 24.

55. The frame memory 47 stores image data being sent through CPU control bus for display on LCD 6. However, the shooting image data which is compressed is temporarily input to the compression unit 34 and decompressed, before the data is supplied to the frame memory 47.

56. Moreover, digital/analog conversion (hereafter D/A conversion) is performed on the sound data which is output from the memory card 24 by the sound IC 38 and is converted to analog signals, after which the signals are supplied to the speaker 5 and output as sound.

57. The flash lamp driving circuit 41 is controlled by CPU 36 and drives the flash lamp 42 embedded in the light emitting unit 4. A red eye reduction lamp driving circuit 43 is also controlled by CPU 36, and drives the red eye reduction lamp 44 embedded in the light emitting unit 4. Red eye reduction lamp 44 is made to emit light immediately before the flash lamp 42 is turned on, which closes the pupils of an object person, reducing the so-called red eye effect in which eyes of a person in the image being shot turn red.

58. A detection circuit 40 converts the voltage of the batteries 21 into digital signals, and supplies the signals to CPU 36. CPU 36 is able to detect remaining life of the batteries 21 by the digital signals supplied from the detection circuit 40.

59. Various handling and operations for the electronic camera 1 of the illustrative embodiment will now be described.

60. To begin, an input/output process for sound information in the illustrative embodiment will be described. When the sound recording switch 12 in surface Y2 is pressed after power is introduced to the electronic camera 1 by the operation of power switch 11, a recording process for sound is started. Sound information is input through the microphone 8 and after A/D conversion and compression processes are executed by the sound IC 38, the results are supplied to CPU 36.

61. The sound data supplied to CPU 36 is transmitted to the memory card 24, and stored or recorded in the sound recording area of the memory card 24. At this time, the recording date data is recorded in the sound recording area of the memory card 24 as header information. This operation is executed continuously as long as sound recording switch 12 is pressed. The sound is illustrated as being compressed using the ADPCM method, but other compression method may be used, as will be understood by persons skilled in the art.

62. Next, the operation of the illustrative embodiment during shooting of a desired object will be described.

63. First, the case in which the continuous shooting mode switching switch 13 in the surface Y2 is switched to S-mode (one-frame mode) is described. To begin, the user operates the power source switch 11 in the surface Y1 to introduce electric power to the electronic camera 1. After verifying the object through the finder 2, the user presses the release switch 10 provided in the surface Y1, which begins the process of shooting the desired object.

64. The optical image of the object observed by the finder 2 is gathered by the shooting lens 3 and imaged on CCD 20. The optical image of the object imaged on CCD 20 is photo-electrically converted to image signals by each pixel, and sampled by the image processing unit 31. The image signal sampled by the image processing unit 31 is supplied to A/D conversion circuit 32 where it is digitized and output to DSP 33.

65. DSP 33 performs a process to generate a color difference signal from the RGB (red, green, blue) signal, and a gamma process which is a non-linear correction process. The compression unit 34 compresses the image data which is supplied by the DSP 33 according to the well known JPEG (joint photographic experts group) method that is a combination of discrete cosine transformation, quantization and Huffman encoding, and records the results in the shooting image recording area of the memory card 24. At this time, the shooting date data is recorded in the shooting image recording area of the memory card 24 as a header information for the shooting image data.

66. Here, when switch 13 is switched to S-mode, only one frame is shot even if the release switch 10 is continuously pressed. Therefore, shooting does not take place beyond one frame, and the single image that is shot is displayed on LCD 6.

67. Next, the case in which the continuous shooting mode switching switch 13 is switched to L-mode (a mode in which 8 frames are shot per second) is described. The user operates the power source switch 11 in the surface Y1 to introduce electric power to the electronic camera 1. Then the user presses the release switch 10 in the surface Y1, which begins the process of shooting the described object.

68. The optical image of the object observed by the finder 2 is gathered by the shooting lens 3 and is imaged on CCD 20. The optical image of the object imaged on CCD 20 is photo-electrically converted to an image signal by each pixel and is sampled eight times per second by the image processing unit 31. Moreover, at this time, the image processing unit 31 samples one fourth of all the pixels in CCD 20. In other words, the image processing unit 31 divides the pixels in CCD 20 which are arranged in a matrix into areas comprising 2×2 pixels (4 pixels) as shown in FIG. 5, and samples the image signal of one pixel in a predetermined position in each area. The remaining 3 pixels are skipped. For example, during the first sampling (first frame), the pixel a which is located on the left upper corner of each base unit is sampled and the other pixels b, c and d are skipped. During the second sampling (second frame), the pixel b which is located on the right upper corner of each base unit is sampled and the other pixels a, c and d are skipped. Likewise, during the third and the fourth sampling, the pixel c and d which are respectively located at the left lower corner and the right corner are sampled and the rest are skipped. In short, each pixel is sampled once during set of four samplings.

69. The image signals (image signals of one fourth of all the pixels in CCD 20) that are sampled by the image process unit 31 are supplied to the A/D conversion circuit 32 where they are digitized and output to DSP 33.

70. DSP 33 performs aforementioned color difference and gamma processing on the digitized image signals, and outputs the results to the compression unit 34. The compression unit 34 JPEG-compresses the image signals and records digitized and compressed image data in the shooting image recording area of the memory card 24 through the CPU control bus. At this time, the shooting date data is recorded as header information of the shooting image data in the shooting image recording area of the memory card 24.

71. Thirdly, the case in which the continuous shooting mode switching switch 13 is switched to H-mode (a mode in which 30 frames are shot per second) is described. After switching power source switch 11 to on-mode, the user presses the release switch 10 in the surface Y1, which begins the process of shooting the desired object.

72. The optical image of the object observed by the finder 2 is gathered by the shooting lens 3 and is imaged on CCD 20, which converts each pixel to an image signal, and is sampled 30 times per second by the image processing unit 31. Moreover, at this time the image processing unit 31 samples one ninth of all the pixels in CCD 20.

73. In other words, the image processing unit 31 divides the pixels in CCD 20 which are arranged in a matrix into areas comprising 3×3 pixels (9 pixels) as shown in FIG. 6, and samples, 30 times per second, the electric signal of one pixel which is arranged on a predetermined position in each area. The remaining 8 pixels are skipped.

74. During the first sampling (first frame) in this mode, the pixel located on the left upper corner of each base unit is sampled, and other pixels b through i are skipped. During the second sampling (second frame), pixel b which is located on the right of a is sampled, and other pixels a and c through i are skipped. Likewise, during the third and the fourth sampling, the pixel c and d are sampled respectively and the rest are skipped. In short, each pixel is sampled once every nine frames.

75. The image signals (image signals of one ninth of all the pixels in CCD 20) that are sampled by the image processing unit 31 are supplied to the A/D conversion circuit 32, where they are digitized and output to DSP 33.

76. DSP 33 performs the aforementioned processing on the digitized image signals, and outputs the results to the compression unit 34. The compression unit 34 performs JPEG compression on the image signals, adds the shooting date supplied by the timer 45 as header information, and records the results in the shooting image recording area of the memory card 24.

77. Next, the operation in which two dimensional line drawing information (pen input information) is input from the touch tablet 6A will be described. When the touch tablet 6A is pressed by the tip of the pen 46, the X-Y coordinate of the contact point is stored in the buffer memory 35 and the data is written in the location corresponding to each point with aforementioned X-Y coordinates in the frame memory 47, and is displayed on LCD 6.

78. The touch tablet 6A formed on the surface of LCD 6 is made of transparent material, hence, the user is able to view the bit pattern being displayed on LCD 6 (point on the location which is pressed by the tip of the pen 46), which gives an impression to the user that the is input is made by the pen directly onto LCD 6. When the pen 46 is moved on the touch tablet 6A, a line tracing the motion of the pen 46 is displayed on LCD 6. Moreover, if the pen 46 is moved intermittently on the touch tablet 6A, a dotted line tracing the motion of the pen 46 is displayed on LCD 6. In this manner, the user is able to input line drawing information of desired letters, drawings and the like from the touch tablet 6A (LCD 6). If the line drawing information is input by the pen 46 when the shooting image is already displayed on LCD 6, the line drawing information is synthesized with the shooting image information by the frame memory 47, and both are displayed together on LCD 6. By operating a color selection switch (not shown), the user is able to choose the color of the line drawing to be displayed on LCD 6 from among black, white, red, blue and other colors.

79. If the execution key 73 of operation key 7 is pressed after line drawing information is input to the touch tablet 6A by the pen 46, the line drawing information which is stored in the buffer memory 35 is supplied with the header information of input date to the memory card 24 through the CPU control bus, and is recorded in the line drawing information recording area.

80. Here, the line drawing information recorded in the memory card 24 is compressed information. The line drawing information input in the touch tablet 6A contains information with a high space frequency component, hence, if the JPEG method is used for compression of the shooting image, compression efficiency becomes poor and the information amount is not reduced, resulting in longer time for compression and decompression. Moreover, compression by the JPEG method is non-reversible compression, and hence is not suitable for compression of line drawing information with a small amount of information. This is because gathering and smearing effects due to missing information become noticeable when information is decompressed and displayed on LCD 6.

81. In the illustrative embodiment, line drawing information is therefore preferably compressed using the run length method which is used in facsimile machines and the like. The run length method, as understood by persons skilled in the art, is a method in which line drawing information is scanned in a horizontal direction and compressed by encoding the continuous length of information (point) of each color such as black, white, red and blue as well as the condition of no pen input.

82. Using the run length method, line drawing information is effectively compressed and control of missing information becomes possible, even when the compressed line drawing information is decompressed. Moreover, it is possible to omit compression of line drawing information if the amount of information is relatively small.

83. As mentioned above, if the line drawing information is input by the pen 46 when the shooting image is already displayed on LCD 6, the line drawing information input by the pen 46 is synthesized with the shooting image information by the frame memory 40, and both are displayed together on LCD 6. On the other hand, in the memory card 24, the shooting image data is recorded in the shooting image recording area and the line drawing information is recorded in the line drawing information recording area. In this manner, two pieces of information are recorded in different areas, hence, the user may be able to erase one of the two images (line drawing, for example) from the synthesized images of shooting image and line drawing, enabling further compression of each image information by separate compression methods.

84. If data is recorded in the sound recording area, the shooting image recording area or the line drawing information recording area, a predetermined display is executed in LCD 6 as shown in FIG. 7. In the display illustrated in FIG. 7, the date of recording information (Aug. 25, 1995, in this case) is displayed at the bottom of the screen with the recording time being displayed at the left end of the screen.

85. To the right of the time of recording, a thumb nail image is displayed. The thumb nail image is created by skipping (reducing) the bit map data of each image data of the shooting image data recorded in the memory card 24. Information shown in this display contains the shooting image information. In other words, information which is recorded (input) at “10:16”, and “10:21” contain shooting image information, but information which is recorded at “10:05”, “10:28”, “10:54” and “13:10” do not contain image information. A memo symbol (*) indicates that a memo is recorded as line drawing information.

86. A sound information bar is displayed on the right of the display area of the thumb nail image and a bar (line segment) with a length corresponding to the recording time length is displayed (the bar is not displayed if the sound information is not input).

87. The order of display of the thumb nail image and the sound information bar is the order (chronological order) in which they are recorded in the memory card 24. In other words, if information to be presented is more than one screen can display, the earliest recording information is displayed in the first line, followed by recording day and time (shooting day and time, input day and time, or recording day and time) displayed in chronological order when the display process of the screen is executed.

88. The user selects and designates information to be reproduced by pressing, with the tip of the pen 46, any desired information in the display line of LCD 6 shown in FIG. 7, and the selected information is reproduced by pressing, with the tip of the pen 46, the execution key 7B as in FIG. 2.

89. For example, if the line for which “10:05” shown in FIG. 7 is pressed by the pen 46, CPU 36 reads sound data corresponding to the selected recording day and time (10:05) from the memory card 24 and supplies the sound data to the sound IC 38. The sound IC 38 decompresses the compressed sound data, executes D/A conversion to convert the data to analog signals, and supplies the analog signals to the speaker 5. The speaker 5 (or ear phone if connected) converts the analog signals to sound output.

90. In reproducing the shooting image data recorded in the memory card 24, the user selects the information by pressing the desired thumb nail image with the tip of the pen 46, then reproduces the selected information by pressing the execution key 7B.

91. CPU 36 reads the shooting image data corresponding to the selected shooting day and time from the memory card 24, and supplies the shooting image data to the compression unit 34. The shooting image data (compressed shooting data) supplied to the compression unit 34 is decompressed there, and output to CPU 36. CPU 36 temporarily stores the shooting image data as bit map data in the frame memory 47, and then displays the shooting image data on LCD 6.

92. The image which is shot with S-mode is displayed as a still image on LCD 6, and is the image reproduced from the image signals of all the pixels in CCD 20.

93. The image shot with L-mode is displayed continuously at 8 frames per second on LCD 6. In this case, the number of pixels being displayed in each frame is one fourth of all the pixels in CCD 20.

94. Human vision is sensitive to deterioration of resolution of a still image, hence the user may easily detect the skipping of the pixels in the still image. However, in L-mode where images of 8 frames are reproduced per second, the number of pixels in each frame becomes one fourth of the number of pixels of CCD 20, but information amount per unit time doubles compared to the still image because images of 8 frames are reproduced per second as described before.

95. That is, assuming the number of pixels of one frame of the image shot in S-mode to be one, the number of pixels in one frame of the image shot in L-mode becomes one fourth. When the image (still image) shot in S-mode is displayed on LCD 6, the amount of information viewed by human eye per second is 1 (=(number of pixels 1)×(number of frames 1)). On the other hand, when the image shot in L-mode is displayed on LCD 6, the information viewed by the human eye per second is 2 (= (number of pixels ¼)×(number of frames 8)) (in other words, twice as much amount of information is viewed by the human eye). Hence, even when the number of pixels in one frame is reduced to one fourth, the user does not perceive much deterioration of the image quality during reproduction.

96. Moreover, in the illustrative embodiment, different sampling is executed for each frame and the sampled pixels are displayed on LCD 6. Hence, residue afterimage effects occur for the human eye and the user may be able to view the image which is shot with L-mode and displayed on LCD 6 without perceiving too much deterioration of the image, even when three fourths of the pixels are skipped per a frame.

97. The image which is shot in H-mode is displayed on LCD 6 at 30 frames per second. At this time, the number of pixels displayed in each frame is one ninth of the total number of the pixels of CCD 20 but the user may be able to view the image which is shot with H-mode and displayed on LCD 6 without perceiving too much deterioration of image quality, because of the same effect as in the case of L-mode.

98. In the illustrative embodiment, when the object is shot in L-mode or H-mode, the image process unit 31 skips the pixels in CCD 20 in such manner that the user does not perceive too much deterioration of image quality during reproduction, which causes the load on DSP 33 and the compression unit 34 to be reduced and enables lowered circuit frequencies and power needs for these units. Cost and energy consumption of the apparatus are reduced.

99. Next, a corresponding reproduction method in which the invention is advantageously applied will be described.

100. FIG. 8 illustrates an example of display of a selection screen for a reproduction mode in the illustrative embodiment. In this figure, “NORMAL” indicates normal reproduction mode, and when this mode is selected, the recorded information is reproduced chronologically (in the order of being recorded in the memory card 24), as in the case of prior art.

101. “REVERSE” indicates reverse reproduction mode, and when this mode is selected, the recorded information is reproduced in reverse chronological order (in the reverse order of storage in the memory card 24). Here, the reverse reproduction mode is equivalent to the case of an event reproduction mode or a daily reproduction mode explained later.

102. “EVENT” indicates an event reproduction mode, and when this mode is selected, reproduction objects are composed with the predetermined time as reference, and reproduction is executed for each reproduction object thus composed. FIG. 9 is a flow chart describing an example of reproduction process using event reproduction mode. This process is made to be executed when “EVENT” described in FIG. 8 is selected.

103. Upon execution of this process, CPU 36 initializes variables i, n and j to be “1”, “2”, and “1” respectively. Moreover, at step S11, CPU 36 initializes the value of (UNIT[1] [1]) of the ordered pair (1,1) where the generated reproduction object is stored to be “1”.

104. Here, UNIT [j] [n] is an ordering by which the value (ordinal number of the recording data) indicating n-th recording data composing j-th reproduction object is stored.

105. Next, at step S12, CPU 36 obtains the recording day and time of the recording data stored in the i-th order in the memory card 24. Here, the recording data in this case indicates an image data, sound data or a line drawing data while the recording day and time indicates a shooting day and time, an input day and time or a sound recording day and time.

106. At step S13, CPU 36 obtains the recording day and time of the recording data which is stored (i+1)st.

107. For example, in an example shown in FIG. 11, information which is recorded first is recording data A, hence the value “1” to be stored in UNIT[1] [1] at step S11 is to indicate the recording data A.

108. Currently i=1, hence, the recording day and time of the recording data which are stored first and second are to be obtained by step S11 and step S12. For example, the recording day and time of the recording data A which is the first and the recording data B which is second are to be obtained in the example shown in FIG. 11.

109. Next, at step S14, CPU 36 computes the difference between the recording day and time of the recording data which are stored i-th and (i+1)st, and determines whether the difference is no more than 30 minutes. As a result, if the time difference is determined to be less than 30 minutes (YES), CPU 36 branches off to step S15, and if the time difference is determined to be greater than or equal to 30 minutes CPU 36 branches off to step S17.

110. At step S14, if the time difference is determined to be less than 30 minutes (YES), CPU 36 branches off to step S15 and substitutes the value (i+1) in UNIT [j] [n]. Then CPU 36 moves to step S16, increments only the value of [n] by 1, and moves to step S19.

111. Currently, j=1, n=2, the value “2” indicating the recording data B (recording data B is the data recorded second) is stored in UNIT [1] [2], assuming that the time difference between the recording data A and B is less than 30 minutes. As a result, the recording data A and the recording data B are considered to be the same reproduction object (reproduction object 1 in FIG. 11).

112. If the time difference between the i-th recording data and the (i+1)st recording data is determined to be greater than or equal to 30 minutes at step S14, CPU 36 branches off to S17. At step S17, only value j is incremented by “1” and the value of n is reset to “1”. Moreover, CPU 36 moves to step S18 and substitutes (i+1) in UNIT [j] [n].

113. CPU 36 increments only the value of i by 1, after which CPU 36 moves to step S20. At step S20, CPU 36 determines whether processing of all the recording data being stored in the memory card 24 is completed. As a result, if CPU determines that processing for all the recording data is not completed (NO), CPU returns to step S12 and repeats a similar process. However, it CPU 36 determines that processing for all the recording data is completed (YES), the process ends (END).

114. Currently, only the process for recording data A and B is completed, hence determination at step S20 is NO, and CPU 36 returns to step S12.

115. In the second process, the time difference between the recording data B and C is determined. Here, suppose that the time difference is less than 30 minutes (YES), so that CPU 36 branches off to step S15 as in the first process. Moreover, because j=1, n=3, i=2 currently, the value 3 (=i+1) is stored in UNIT [1] [3] at step S15. In other words, the recording data C (the third recording data) is to be the third composition element on the first reproduction object (corresponding to the reproduction object 1 in FIG. 11).

116. Moreover, unprocessed recording data remains at step S20, hence, CPU 36 makes a negative determination (NO) and returns to step S12.

117. In the third process, CPU 36 compares the time difference between the recording data C and the recording data D, and as a result, CPU 36 determines that the time difference is greater than or equal to 30 minutes (NO) and moves to step S17. At step 17, the value of j is incremented only by “1” and n is reset to be “1”. Moreover, at step S18, the value (i+1) is substituted in UNIT [j] [n].

118. Now, the process at step S17 results in j=2 and n=1, moreover i=3, hence, the value 4 (=3+1) is stored in UNIT [2] [1]. In other words, the recording data D (4th recording data) is to be the first composition element of the second reproduction object (corresponding to the reproduction object 2 in FIG. 11) .

119. Repeating a similar process, the reproduction objects 1 through 4 shown in FIG. 11 are composed. In other words, values 1 through 3 indicating the recording data A through C are stored in UNIT [1] [1] through UNIT [1] [3] respectively that are first reproduction objects, value 4 indicating the recording data D is stored in UNIT [2] [1] that is a second reproduction object, values 5 and 6 indicating recording data E and F are stored in UNIT [3] [1] through UNIT [3] [2] respectively that are third reproduction objects, and values 7 through 10 indicating the recording data G through J are stored in UNIT [4] [1] through UNIT [4] [4] respectively that are is fourth reproduction objects.

120. Here, in the example of FIG. 11, the recording data E and F are recorded on May 21 and May 22 respectively but because the time difference is less than 30 minutes, they are considered to be the same reproduction object. The reason for execution of such process is that the data which are recorded within a predetermined time (30 minutes in the illustrative embodiment), in most cases, are information relating to the same event.

121. Moreover, in the embodiment illustrated above, the reproduction objects are considered to be the same if the time difference of the data is less than 30 minutes, but the invention is not limited to frames of 30 minutes. The time difference may for instance be set by the user.

122. FIG. 10 is a flow chart illustrating an example of a process to reproduce recording data based on the reproduction object composed by the process of FIG. 9. This process continues to be executed after execution of the process described in FIG. 9.

123. Upon execution of step S40, CPU 36 initializes the variable i to be “1” and substitutes the value of j (the number of reproduction objects) into the variable J that is obtained by the process of FIG. 9. Then CPU 36 moves to step S41 and reproduces the recording data corresponding to the value (the ordinal number of the recording data) that is stored in UNIT [J] [n].

124. Currently J=4 (the number of reproduction objects=4), hence, the recording data G corresponding to the value “7” (indicates the recording data G that is recorded 7th) is read and reproduced from the memory card 24. In other words, when the recording data is image data, CPU 36 reads the recording data G from the memory card 24 and supplies it to the compression unit 34. As a result, the recording data G is displayed in LCD 6.

125. Moreover, at step S42, the value of n is incremented by only 1 and CPU 36 moves to step S43. At step S43, CPU 36 determines whether a value is stored in UNIT [J] [n]. In other words, if UNIT [J] [n]=NULL (=0), CPU 36 determines that the nth data of the J-th reproduction object does not exist, and moves to step S44. Moreover, if UNIT [J] [n] is NULL (=0), the nth data of the T-he reproduction unit exists, and CPU 36 returns to step S41 to repeat similar process.

126. Currently, the first process is being executed with J=4 and n=2, hence, UNIT [J] [n]=8 (the ordinal number indicating recording data H) at step S43, and CPU 36 makes a negative determination (NO) and returns to step S41.

127. If a positive determination (YES) is made at step S43, CPU 36 moves to step S44 and J is decremented by 1 and n is reset to 1, and CPU 36 moves to step S45. At step S45, CPU 36 determines whether UNIT [J] [n]=NULL (=0). If the result of determination is UNIT [J] [n] is NULL (=0) (NO), (recording data exists), CPU 36 returns to step S41 and repeats a similar process. Moreover, if the result of determination is UNIT [J] [n]=NULL (YES) (recording data does not exist), CPU 36 ends the process (END).

128. The reproduction process of the reproduction object shown in FIG. 11 is repeated, n=4 and if recording data J of reproduction object 4 is reproduced in the process at step S41, CPU 36 determines that UNIT [4] [5]=NULL (the fifth recording data of the fourth reproduction object does not exist (YES)), hence, CPU 36 moves to step S44. As a result of the process of step S44, J=3 and n=1, hence CPU 36 determines that UNIT [3] [1] is NULL (the first recording data of the third reproduction object exists (NO)) and CPU 36 returns to step S41.

129. Moreover, in the next step, recording data E and F of the third reproduction object are reproduced in following order, then recording data D of the second reproduction object is reproduced, and recording data A, B and C of the first reproduction object are reproduced in following order.

130. In the process above, recording data are compiled by event and are reproduced in chronologically reversed order, enabling quick reproduction of desired information.

131. Moreover, if “DAILY” is selected in FIG. 8, a process illustrated in FIG. 12 is executed.

132. In this figure, description of the process other than the process of step S62 through S64 will be omitted since they are same as the case of FIG. 9. In this process, the recording date of the i-th recording data is obtained at step S62. Moreover, recording date of (i+1)st recording data is obtained at step S63. At step S64, CPU 36 determines whether the i-th and the (i+1)st recording data have the same recording date (whether or not they are recorded on the same day). Other steps are same as the case in FIG. 9.

133. With such process as above, recording data that are recorded on the same recording date become the same reproduction object, hence, reproduction objects such as those shown in FIG. 13 are composed.

134. In other words, values 1 through 3 indicating the recording data A through C are stored respectively in UNIT [1] [1] through UNIT [1] [3], which are the first reproduction objects, values 4 and 5 indicating the recording data D and E are stored respectively in UNIT [2] [1] through UNIT [2] [2], which are the second reproduction objects, and values 6 through 10 indicating the recording data F through J are stored respectively in UNIT [3] [1] through UNIT [3] [5], which are the third reproduction objects.

135. Reproduction objects composed by the process above, are reproduced in the following order of F, G, H, I, J in FIG. 11 by a process described in FIG. 10, followed by reproduction of D, F and finally by reproduction of A, B, and C.

136. In such a process as detailed above, reproduction objects may be composed from the recording data according to recording date, and hence desired information may be reproduced quickly.

137. If “CALENDAR” is selected In FIG. 8, a calendar shown in FIG. 14 is displayed.

138. In this calendar, a “i” mark is attached on the date in which the data is recorded as illustrated in FIG. 14, hence, the existence of recording data is easily noted. In displaying a calendar like this, if the most current month is made to be displayed first in the calendar out of all the months in which recording is executed, reproduction of recording data may executed effectively. A change of the month in the calendar being displayed may be accomplished simply by pressing the scroll key 7E with the pen 46. A calendar for only one month is displayed in the example, but several months may be displayed simultaneously.

139. In such calendar displays as described above, if the date with “i” mark attached is pressed by the pen 46, a process illustrated in FIG. 15 is executed. Upon execution of this step, CPU 36 initializes the variable i to be 1 at step S90. Then CPU 36 moves to step S91 and obtains the recording date of the first recording data which is stored in the memory card 24. Then at step S92, CPU 36 determines whether the recording date of the i-th recording data is the same as the recording date which is designated on the calendar.

140. If CPU 36 determines that the recording date of the i-th recording data is the same as the recording date designated on the calendar (YES), CPU 36 moves to step S93, but if CPU 36 determines that the recording date of the i-th recording data is the not same as the recording date designated on the calendar (NO), CPU 36 skips step S93 and moves to step S94.

141. At step S92, if CPU 36 determines that the recording date of the i-th recording data is the same as the recording date designated on the calendar (YES), CPU 36 moves to step S93 and reproduces the i-th recording data, and moves to step S94.

142. If the date designated on the calendar is “1” (May 1st) currently, in the first process (i=1), the recording date of the recording data A (first recording data) described in FIG. A is read from the memory card 24, and since a positive determination is made (YES) at step S92, the reproduction of recording data A is started at step S93.

143. At step S94, the value of i is incremented by only 1 and CPU 36 moves to step S95. At step S95, CPU 36 determines whether the i-th data exist, and if determination is affirmative (YES), CPU 36 returns to step S91 and repeats a similar process. Moreover, if CPU 36 determines that i-th data does not exist (NO), CPU 36 ends the process (END).

144. Currently, i=1, hence as a result of step S94, i=2. Moreover, at step S95, CPU 36 determines that the second recording data (corresponding to recording data B shown in FIG. 11) exists, and returns to step S91. Moreover, during the second process, recording data B shown in FIG. 11 is reproduced. Next, during the third process, recording data C is reproduced. During the subsequent process, CPU 36 determines, at step S92, that the i-th recording date and the date designated on the calendar are not the same (NO), hence, reproduction of recording data is not executed, and at step S95 in the 10th process, CPU 36 determines that the i-th (11th) data does not exist and ends the process.

145. In such processes as described above, reproduction of recording data is enabled by designating a predetermined date on the calendar, hence reproduction of desired data may be achieved quickly.

146. If “THUMB NAIL” is selected in FIG. 8, the thumb nail reproduction mode is enabled. Upon execution of the thumb nail reproduction mode, the screen shown in FIG. 7 is displayed, and the recording data which is selected in this display screen is reproduced as described.

147. If recording data such as one shown in FIG. 11 exists in the case of displaying a display shown in FIG. 7, effective reproduction of recording data is achieved if data of the closest date (recording data F through J) is displayed first. If not all the thumb nails are displayed on the screen, the thumb nail of recording data F, for example, may be displayed at the top of the screen, with as many remaining thumb nails as possible from recording data G through recording data J be displayed. Or, the thumb nail of recording data J may be displayed at the bottom of the screen, then as many recording data from recording data I through F as possible may be displayed from the bottom to top, in order.

148. Here, reproduction of recording data may be possible even when a calendar is displayed during a mode other than reproduction mode (line drawing input mode, for example).

149. FIG. 16 illustrates an example of a calendar displayed in a mode other than reproduction mode. In the calendar displayed during a mode other than the reproduction mode, a “i” mark is not attached on the date when the data is input, unlike the case of FIG. 14.

150. In such a calendar, if a predetermined date is double-clicked by the pen 46 (pressing twice the same location in the touch tablet 6A), the process shown in FIG. 17 is executed.

151. Upon execution of process shown in FIG. 17, CPU 36 initialize variables i and min to be 1 and 100 respectively, and substitutes into the variable “cal” date and year designated on the calendar. At step S111, CPU 36 reads the recording date of i-th recording data form the memory card 24 and substitutes the recording date into the variable “date”.

152. At step S112, CPU 36 determines whether the absolute value of the difference between “cal” and “date” is smaller than min. As a result, if the absolute value of the difference between “cal” and “date” is determined to be smaller than min (YES), CPU 36 moves to step S113. If the absolute value of the difference between “cal” and “date” is determined to be greater than or equal to min (NO), CPU 36 skips the process at S113 and moves to step S114.

153. If the absolute value of the difference between “cal” and “date” is determined to be smaller than min (YES) at step S112, CPU 36 moves to step S113 and the absolute value of the difference between “cal” and “date” is substituted into min, the value of i is substituted into h, and CPU 36 moves to step S114. At step S114, i is incremented by only 1, and CPU 36 moves to step S115.

154. At step S115, CPU 36 determines whether or not i-th recording data exists and if i-th recording data is determined to exist (YES), CPU 36 returns to step S111 and repeats a similar process. Moreover, if i-th recording data is determined not to exist (NO), CPU 36 moves to step S116.

155. Suppose “2” (May 2) is selected currently in the calendar described in FIG. 16 and the recording data is recorded in the order shown in FIG. 11. In this case, at step S111 during the first process, recording date of the first recording data A is read from the memory card 24. Moreover, at step S112, the absolute value of the difference between “cal” and “date” is compared with the value in min.

156. Now the difference between cal (May 2) and date (May 1) is one day, hence when this value 1 is compared to the initial value 100, an affirmative determination (YES) is made and CPU 36 moves to step S113. At step S113, the value 1 is substituted into min and the value of i (=1) is substituted into h. At step S114, the value of i is incremented by only 1 and CPU 36 makes a negative determination (NO) at step S115 (second recording data exists), and returns to step S111.

157. At step 112 during the second process, the absolute value of the difference between the recording date of the second recording data B and cal is compared to the value in min but because the value of min is made to be 1 during the first process, the value of |cal− date| is determined to be equal to the value of min (NO), hence CPU 36 skips step S113 and moves to step S114. Because the same holds true during the third process and thereafter, the values of min (=1) and h (=1) are maintained. Moreover, at step S115 during the tenth process, CPU 36 makes a negative determination (the 11th data do not exist), and moves to step S116.

158. At step S116, CPU 36 substitutes the value of h into i. Then CPU 36 moves to step S117, reads the i-th recording data from the memory card 24 and begins reproduction of the i-th recording data. Upon completion of reproduction, CPU 36 moves to step S118 and increments the value of i by only one.

159. At step S119, CPU 36 determines whether the recording date of the i-th and the (i−1)st data are the same. In other words, CPU 36 determines whether the recording date of the recording data to be reproduced next and the recording date of the recording data reproduced immediately before at step S117 are the same. As a result, if CPU 36 determines that the recording date of the i-th and the (i−1)st data are the same (YES), CPU 36 returns to step S117 and repeats a similar process. Moreover, if CPU 36 determines that the recording date of the i-th and the (i−1)st data are not the same (NO), CPU 36 ends the process (END).

160. Currently, h=1, hence, “1” is substituted into i at step S116. The i-th recording data A is reproduced at step S117. Moreover, i is incremented by only 1 at step S118, and CPU 36 moves to step S119. At S119, CPU 36 determines that the recording date of (i−1)st (=1) recording data is same as the recording date of i-th (=2) recording data (YES), and returns to step S117. Subsequently, reproduction of the recording data B and the recording data C are executed in the same manner and during the 4th loop, CPU 36 determines that the recording dates of the i-th and (i−1)st recording data are not the same (NO), and ends the process.

161. In the process described above, even if the data recorded on the date designated in the calendar does not exist, the recording data having the recording date which is closest to the designated date is reproduced. Moreover, if the data recorded on the designated date exists, that data is reproduced.

162. In the process above, if the recording data which are the same number of days apart from the designated date exist (for example data recorded on May 22 and May 21 exist when May 21 is designated in the calendar), the recording date with the earlier date (May 20 in the example) is reproduced. However, in such a situation, it may be arranged to reproduce the recording data with a later date or to reproduce both data in specific order (for example, the later recording data reproduced first, followed by the earlier data or visa versa).

What is claimed is:

1. An information processing apparatus of the type which records information, comprising;
input means for inputting information;
clock means for clocking day and time information;
recording means for recording the information input from the input means, and for recording day and time information from the clock means at the time of inputting the information;
composition means for composing a reproduction object according to the day and time information recorded by the recording means;
selection means for selecting, in desired order, at least one reproduction object composed in the composition means; and
reproduction means for reproducing the information contained in the reproduction object selected by the selection means, according to the day and time information recorded in the recording means.

2. An information processing apparatus of claim 1, wherein the selection means selects the reproduction object in the order of the earliest day and time information.

3. An information processing apparatus of claim 1, wherein the selection means selects the reproduction object in the order of the latest day and time information.

4. An information processing apparatus of claim 2 wherein the reproduction means reproduces the information contained in the reproduction object selected by the selection means in the order of the earliest day and time information.

5. An information processing apparatus of claim 3, wherein the reproduction means reproduces the information contained in the reproduction object selected by the selection means in the order of the latest day and time information.

6. An information processing apparatus of claim 5, wherein the composition means composes the reproduction object using one day as a unit.

7. An information processing apparatus of claim 5, wherein the composition means composes a predetermined reproduction object if the time difference between the input day and time information of a first input information, and the input day and time of a second input information recorded immediately before or immediately after the first input information, is within a predetermined time interval.

8. An information processing apparatus of the type which records information, comprising:
input means for inputting information;
clock means for clocking day and time information;
recording means for recording the information input from the input means, and for recording day and time information at the time of inputting the information;
calendar display means for displaying a calendar;
designation means for designating predetermined day and time information in the calendar displayed by the calendar display means;
retrieval means for retrieving information having day and time information designated by the designation means matching that of the day and time information from the recording means; and
reproduction means for reproducing information retrieved by the retrieval means.

9. An information processing apparatus of claim 8, wherein the retrieval means retrieves information having the latest input day and time, if no information having the day and time designated by the designation means matches the day and time information from the recording means.

10. An information processing apparatus of the type which records information, comprising;
an input unit for inputting information;
a clock producing day and time information;
a recording unit, connected to the input unit and the clock, which records the information input from the input and day and time information from the clock produced at the time of inputting the information;
a composition unit, connected to the recording unit, for composing a reproduction object according to the day and time information in the recording unit;
a selection unit, connected to the recording unit, which selects in predetermined order, at least one reproduction object composed in the composition unit; and
a reproduction unit, connected to the recording unit, which reproduces the information contained in the reproduction object selected by the selection unit, according to the day and time information in the recording unit.

11. An information processing apparatus of claim 10, wherein the selection unit selects the reproduction object in the order of the earliest day and time information.

12. An information processing apparatus of claim 10, wherein the selection unit selects the reproduction object in the order of the latest day and time information.

13. An information processing apparatus of claim 11, wherein the reproduction unit reproduces the information contained in the reproduction object selected by the selection unit in the order of the earliest day and time information.

14. An information processing apparatus of claim 12, wherein the reproduction unit reproduces the information contained in the reproduction object selected by the selection unit in the order of the latest day and time information.

15. A method for processing information, comprising the steps of;
inputting information;
clocking day and time information at the time of the inputting;
recording the information input and the day and time information clocked at the time of inputting the information;
composing a reproduction object according to the day and time information recorded by the step of recording;
selecting, in desired order, at least one reproduction object composed in the composing step; and
reproducing the information contained in the reproduction object selected by the step of selecting, according to the day and time information means.

16. A method of claim 15, wherein the step of selecting comprises the step of selecting the reproduction object in the order of the earliest day and time information.

17. An method of claim 15, wherein the step of selecting comprises the step of selecting the reproduction object in the order of the latest day and time information.

18. A method of claim 16, wherein the step of reproducing comprises the step of reproducing the information contained in the reproduction object selected in the order of the earliest the day and time information.

19. A method of claim 17, wherein the step of reproduction comprises the step of reproducing the information contained in the reproduction object in the order of the latest day and time information.

20. A method of claim 15, wherein the step of composing comprises the step of composing a predetermined reproduction object if the time difference between the input day and time information of a first input information, and the input day and time of a second input information recorded immediately before or immediately after the first input information, is within a predetermined time interval.
